(19) United States
(12) Patent Application Publication
(10) Pub. No.: US 2008/0166790 A1
(43) Pub. Date: Jul. 10, 2008

(54) Method And System For The Transformation Of Molecules: A Process Used To Transform Waste Into Energy And Feedstock Without Releasing Carbon Dioxide Greenhouse Gas Emissions

(76) Inventor: Eric Day, Longmeadow, MA (US)

Correspondence Address: Eric Day, 325 Williams St., Longmeadow, MA, 01106, US

(21) Appl. No.: 11/680,704

(22) Filed: Mar. 1, 2007

Related U.S. Application Data
(63) Continuation of application No. 11/620,018, filed on Jan. 4, 2007.
Application No. 11/620,018 is a continuation of application No. 11/621,801, filed on Jan. 10, 2007.
Application No. 11/621,801 is a continuation of application No. 11/624,240, filed on Jan. 18, 2007, now abandoned.
Application No. 11/624,240 is a continuation of application No. 11/627,403, filed on Jan. 26, 2007.

(51) Int. Cl. A62D 3/02

(52) U.S. Cl. 435/262.5; 435/289.1

(57) ABSTRACT

The system, based on an enclosed recirculating Carbon Flow Loop, uses plasma to neutralizes toxins within municipal waste or other feedstock. This breaks down the feedstock into its basic elements, predominantly hydrogen and carbon monoxide, known as syngas. The syngas is further processed using combustion, to transform the carbon monoxide into carbon dioxide. The carbon dioxide gas flow continues in the Carbon Flow Loop to an Algae Bioreactor. Here photosynthesis of algae transforms the carbon dioxide into an oil rich carbohydrate. This can either continue in the Carbon Flow Loop as feedstock, and/or exit the loop, and be used to manufacture biofuels or other products. New feedstock is added to the system to replace removed carbon.

### FIELD OF INVENTION

Our planet is being poisoned by toxic waste, while waste is not being put to useful work:

1. Carbon Dioxide emissions from combustion engines, (used in power stations etc.) and rotting waste are creating global warming gasses. This could contribute to destroying the planet as we know it. The process may soon be irreversible.

2. Toxic waste from industrial processes and landfills is finding its way into our ground water supply.

3. Medical waste and dangerous bacteria need to be completely destroyed.

4. Landfills release methane into the atmosphere. Methane is 23 times more effective over a 100 year period at trapping heat as carbon dioxide.

5. Landfills and other waste streams are not being utilized as a resource.

The need to address these problems is urgent and compelling.

It is known that photosynthesis of algae creates carbohydrates by combining carbon dioxide with water. Plasma Syngas Gasifiers break down substances to their basic elements by exposing them to the very high temperatures of an electric arc in ionized gas. Syn-gas engines release energy for useful work with steam and carbon dioxide as the exhaust gas.

This invention is a system which uses these processes and heat recovery techniques to form an efficient and practical way of cleaning up toxic waste and other refuse. It also provides oil rich algae for bio-fuels or other uses, and generates electricity without carbon dioxide greenhouse gas emissions. By using landfills and other waste streams as a recoverable energy source, we reduce our dependency on petroleum oil.

### BACKGROUND OF INVENTION

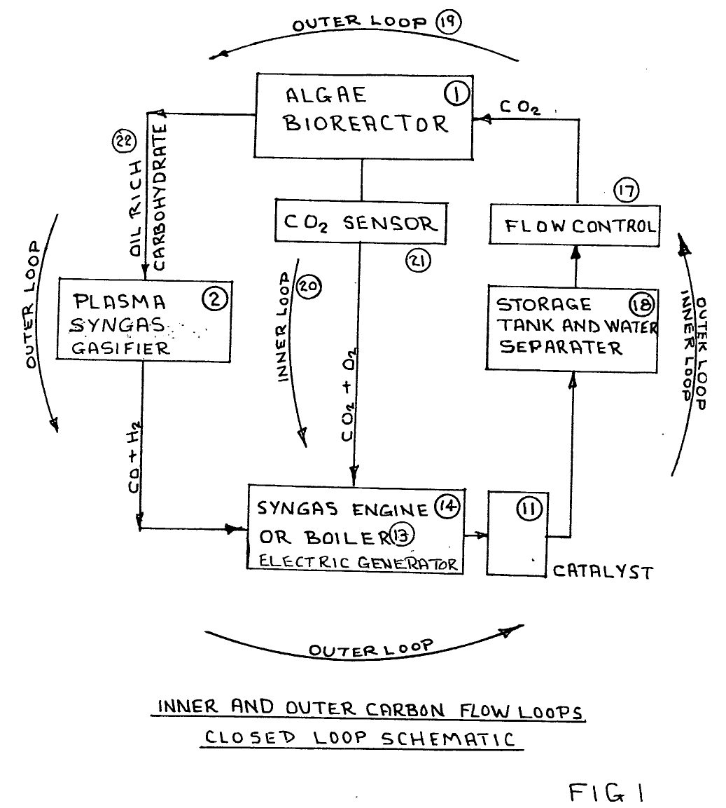

Building blocks for this system as shown in FIG. 1 are known:

1. Algae Bioreactors use fast growing Algae, which in the presence of sunlight in a warm environment, feed on carbon dioxide, to become a valuable source of oil rich carbohydrate. Carbon Dioxide is thus converted from a global warming pollutant into useful fuel feedstock rich in hydrogen and vegetable oil.

i.e.

Carbon Dioxide+Water+Plus sunlight→Glucose+Water+Oxygen

6CO₂+12H₂O+Plus sunlight→C₆H₁₂O₆+6H₂O+6O₂

In general terms the transformation is as follows:

$$n {CO}_{2} + 2 {n H}_{2} + \frac{ATP}{NADPH} \to \begin{matrix}Carbohydrate + \\ {( C {H}_{2} O )}_{n} +\end{matrix} \begin{matrix}Water + \\ n {H}_{2} O +\end{matrix} \begin{matrix}Oxygen \\ n {O}_{2}\end{matrix}$$

Where n is defined according to the structure of the resulting carbohydrate,
ATP is adenosine triphosphate,
NADPH is nicotinamide adenosine dinucleotide phosphate.

Whereas hydrocarbons are typically defined as: CnH₂n+₂. They lack Oxygen.

2. Plasma Syngas Gasifiers can achieve temperatures hotter than the sun's surface, by striking an electric arc through ionized gas, in much the same way as a lightning bolt. At these elevated temperatures, with an oxygen depleted atmosphere, molecules within compounds are transformed into their basic elements.

Hydro Carbons and carbohydrates are split into carbon monoxide and hydrogen. Base metals and silica form part of a molten discharge. These can be drained off to solidify on cooling. The non-precious slag can be used as a building material and for other industrial products.

i.e.

Hydro Carbon and Carbohydrate Feedstock+Heat Absorption→Syngas
Syngas, is mainly carbon monoxide CO and hydrogen H₂

3. Syn-gas Engines ignite the hydrogen and carbon monoxide gasses in the engine combustion chamber and can be used to drive an electric generator or other devices. The exhaust “gasses” from this process are steam, inert gasses and carbon dioxide, which can be fed back to the Algae Bioreactor after recovering heat energy for useful work, i.e.

Syn-gas+Oxygen+Heat Release→Carbon dioxide+Steam

4. To achieve optimum system efficiency, it is necessary that waste heat be captured and put to useful work. By recovering heat from the Plasma Syngas Gasifier and Syngas Engine, and using it to power an electric generator, the system can be self-sustaining.

### OBJECT OF INVENTION

1. To generate electricity without releasing carbon dioxide greenhouse gasses into the atmosphere

2. To provide a closed recirculating Carbon Flow Loop method and system, as a means of gathering, transporting and harvesting hydrogen.

3. To produce heat energy and/or electricity from landfill sewage and other feedstock, while harvesting oil rich algae. This can be used to produce ethanol, other alcohols, bio-diesel and solid biomass etc. It can also be used as a high energy feedstock, for the Plasma Syngas Gasifier.

4. To provide a self sustaining power generation system which uses landfill, sewage and other waste as feedstock.

5. To provide alternative system configurations, with overnight operating capability.

### SUMMARY OF INVENTION

### Carbon Loops

The system is based on two carbon loops, the inner loop and the outer loop reference FIG. 1. The outer loop circulates carbon in various forms as a means of gathering, transporting and harvesting hydrogen. The Algae Bioreactor converts carbon dioxide and water into carbohydrate (carbon+hydrogen+oxygen). This feedstock can be substituted with other carbon containing feedstock from landfill sewage or other waste, and fed to the Plasma Syngas Gasifier, where it is converted into syn-gas (carbon monoxide+hydrogen). During the combustion process that follows either in the Syn-gas Engine (Item 14) or Boiler (Item 13), it is converted into carbon dioxide and steam. It is then fed to the Catalyst (Catalytic Converter) to ensure conversion of any remaining carbon monoxide into carbon dioxide. From here it is transferred to Storage Tank (Item 18) or other containment, which stores and separates the carbon dioxide and water. The carbon dioxide then flows to the Flow Control Valve (Item 17), and the water to the Bioreactor as needed. The Flow Control Valve supplies a regulated flow of carbon dioxide to the Bioreactor, as dictated by the Carbon Dioxide Sensor in the inner loop.

In the inner loop, the carbon dioxide not digested by the algae in the Bioreactor, plus the oxygen released during photosynthesis, are fed via the Carbon Dioxide Sensor to the Syn-gas Engine. During engine combustion, oxygen combines with the syn-gas to form carbon dioxide and steam, while the carbon dioxide passes through as an inert gas. The gasses then become part of the Outer Loop. This provides an overall means of gathering, transporting and harvesting hydrogen without emitting carbon dioxide greenhouse gas to atmosphere.

### Closed Loop Feedback Control System

The Bioreactor algae field is sized to match the system output during specified minimum climatic conditions, light intensity, temperature, photo period, etc. Sufficient algae mass for carbon digestion is also an important variable.

Within this system configuration variations in the Bioreactor output can be adjusted such that the amount of carbon dioxide being supplied to the Bioreactor corresponds with the amount of carbon dioxide the algae can digest.

By measuring the carbon dioxide flow rate in the inner loop and referencing the amount to a targeted value, continuously governed control of the Flow Control Valve (Item 17) is accomplished. A standard (proportional, derivative, differential or similar device) electric governor would be suitable for this closed loop feedback system, which senses the error from the target and continuously corrects the carbon dioxide delivered by Flow Control Valve (Item 17)

To regulate the amount of carbon dioxide in Storage Tank (Item 18), a variable storage level may need to be established. This would occur if there is a need to store nighttime generated carbon dioxide when photosynthesis in the Bioreactor is not taking place. To accommodate this, the dawn level of carbon dioxide will be at the high point and the dusk level at the low point.

With the targeted contents of the tank defined in this way, the level of carbon dioxide in the tank can be monitored and referenced to the targeted values throughout the day, i.e. if the Storage Tank level is too high then the Plasma Reactor output will need to be reduced. This will be accomplished by reducing the electric current flow to the Plasma Syngas Gasifier.

### Chemical Balance

The Algae Bioreactor carbon balance is as follows:

$$\begin{matrix}carbon fed to Algae Bioreactor & - \\ ( carbon dioxide ) & \end{matrix} \begin{matrix}carbon to Inner Loop & = & Algae Bioreactor output carbon \\ ( carbon dioxide ) & & ( oil rich carbohydrate )\end{matrix}$$

In a hypothetical steady state system flow ref FIG. 1, the carbon in the Algae Bioreactor carbohydrate output, would equal the carbon in the Plasma Syngas Gasifier syn-gas output. i.e. if all the carbohydrate from the Algae Bioreactor were fed to the Plasma Syngas Gasifier, and no carbon was removed from the system, no other feedstock could be added, and the same carbon flow rate would exist throughout the system Outer Loop. To accommodate the nighttime shutdown of the Bioreactor however, the Plasma Syngas Gasifier may be set to run all day and the Bioreactor be sized to digest the carbon dioxide during daylight hours only.

### Feedstock Moisture Control

For the Plasma Syngas Gasifier to supply syn-gas (carbon monoxide and hydrogen), the supply of oxygen needs to be carefully controlled. Oxygen in the form of air, steam or water in the Plasma Syngas Gasifier initially increases the formation of carbon monoxide, and then transforms this into carbon dioxide. In the case where excess moisture (H₂O) in the feedstock, creates the need to reduce the oxygen level in the Plasma Syngas Gasifier, this could be done by adding dry hydrocarbon (i.e. dry used tires) to the feedstock. The input rate being adjusted (by modulating the electric current feed to the plasma torch) to meet the system syn-gas output requirement.

With this sensitivity, the dryness of the feedstock can be seen to be critical, and needs good process control. Tornado dryers and/or other moisture evaporation equipment may need to be employed to control this. Carbohydrate feedstocks are more sensitive to this problem since their makeup includes oxygen atoms.

### Night Time Operation

For nighttime operation two additional open loop operating modes could be used, although these are listed individually, they are not mutually exclusive and each may be used as needed:

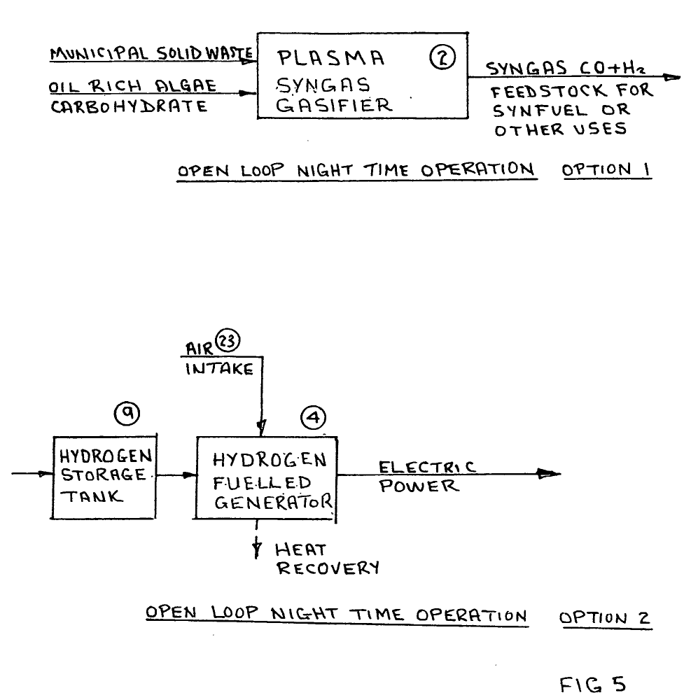

### 1. Syn-Fuel Production (FIG. 5, Option 1)

The syn-gas produced by the Plasma Syngas Gasifier can be used as a feedstock for the Fischer Tropes type process to produce synthetic fuels, fertilizer, plastics and other products.

### 2. Hydrogen Storage (FIG. 5, Option 2)

By storing hydrogen during daylight operation, a reserve fuel supply can be maintained, for use when the Algae Bioreactor is shut down. The Hydrogen Fuelled Generator or fuel cell operated from a reserve hydrogen fuel supply would allow electrical power to be generated without emitting carbon dioxide greenhouse gasses. Combustion of hydrogen and oxygen produces steam. As a backup to this, other energy storage devices could be used. Battery storage or other chemical, potential energy, and kinetic energy devices are available.

### Improved Thermal Efficiency

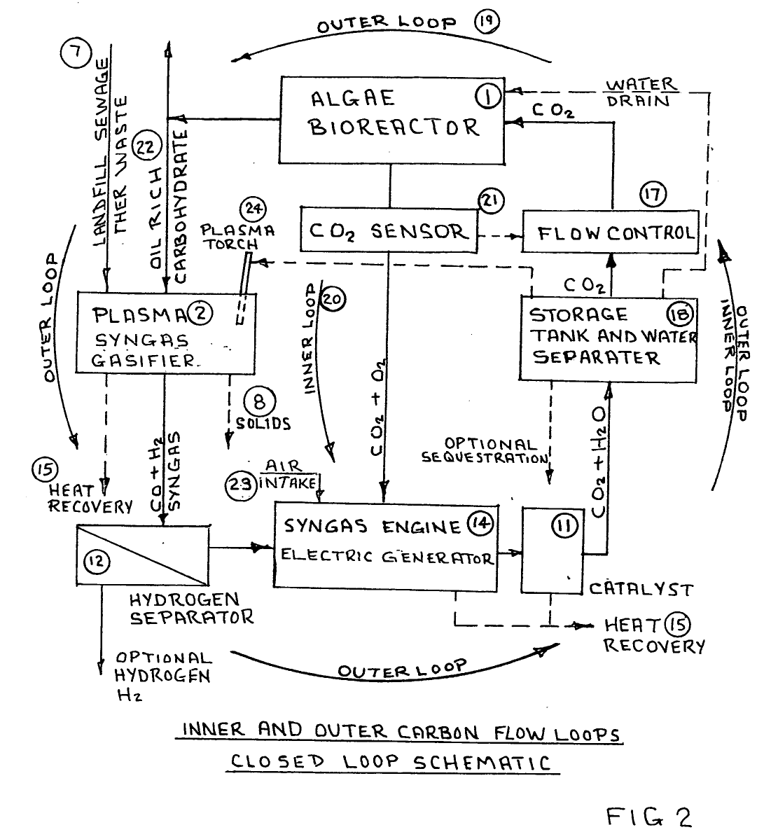

Heat Recovery item 15, from the Plasma Syngas Gasifier item 2, the Gasifier molten discharge item 8, the Catalyst. item 11, and the Syn-gas Engine (Item 14 FIG. 2), configured for co-generation, can be used for many industrial processes, including electric power generator. To improve low temperature heat recovery, Kalina cycle, Ormat, or low temperature turbines can be used. These units use waste heat to evaporate refrigerant type gasses. These can be used to power a low temperature gaseous turbine engine, which drive a generator, to supplement the electric power provided by the Generator Engine (Item 14, FIG. 2). Specific use of these technologies will depend upon the size of the system and the emphasis placed on heat recovery.

### Design Variations

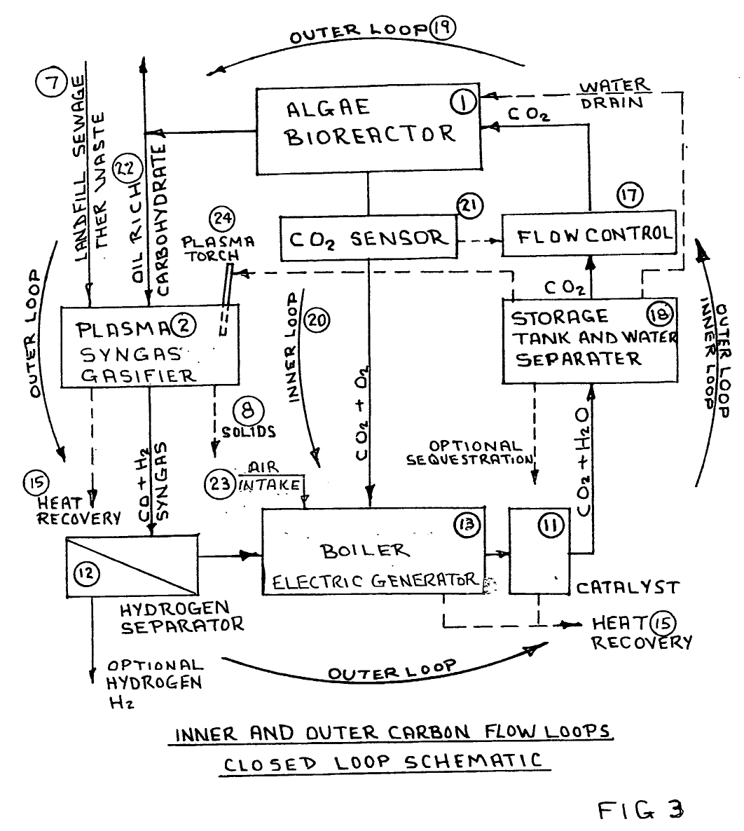

Two options are offered for consideration. These are shown on FIG. 2 and FIG. 3:

In FIG. 2. the system generates electricity using the Syn-gas Engine and by using recovered waste heat.

In FIG. 3. the system generates electricity using the Syn-gas Boiler and by using recovered waste heat.

### BRIEF DESCRIPTION OF DRAWINGS

Item 1. Algae Bioreactors FIG. 1 through 4, Photosynthesis of the algae in the presence of sunlight quickly grows more oil rich algae by combining carbon dioxide with water. CO₂ is thus converted from a global warming pollutant into useful fuel feedstock rich in hydrogen. Undigested carbon dioxide and oxygen released during photosynthesis are fed to the Inner Loop.

Item 2. Plasma Syngas Gasifiers ref FIG. 1 through 5, Ionized gas known as plasma is a good conductor of electricity. An electric arc struck within the plasma can produce temperatures greater than 30,000 degrees Fahrenheit (F). Within an oxygen depleted atmosphere at these temperatures both hazarded and non-hazardous materials in the feedstock are broken down into their basic elements. Municipal solid waste feedstock comprising typically of carbohydrates CH2O and hydrocarbons CH2, break down into similar amounts of carbon monoxide CO and hydrogen H2, with approximately 10% inert gasses. This is known as syngas.

Item 4, Hydrogen Generator Engine ref. FIG. 5, is a hydrogen powered electric generator.

Item 7, Municipal Solid Waste ref FIGS. 2 through 4, is the primary feedstock used by these systems. Other hydrocarbon or carbohydrate based waste such as used truck or car tires, used engine oil or industrial waste are also suitable.

Item 8. Metal. Silica Other solids, ref. FIGS. 2 through 4, which do not gasify into their natural elements drain off in a molten discharge.

Item 11, Catalytic Converter. Ref FIG. 6, converts carbon monoxide into carbon dioxide for digestion by the Algae Bioreactor. Heat generated forms part of the heat recovery process ref item 15

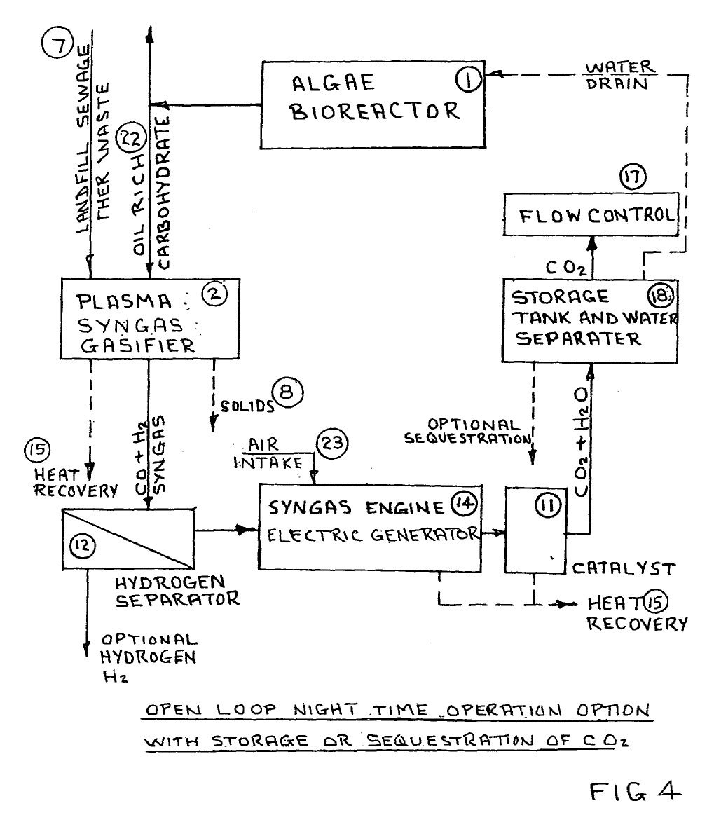

Item 12, Hydrogen Separator, ref FIG. 2, FIG. 3, FIG. 4 A fine porous membrane can be used, such that hydrogen can pass through it, but not larger molecules such as carbon dioxide.

Item 13, Boiler Electric Generator, ref FIG. 1, FIG. 3, ignites syngas (carbon monoxide and hydrogen). It is used to drive an electric generator. The exhaust “gasses” from this process are carbon dioxide and steam.

Item 14, Syngas Engine Electric Generator, ref. FIG. 1, FIG. 5, is an internal combustion engine which ignites syngas (carbon monoxide and hydrogen) with oxygen in the engine combustion chamber. It is used to drive an electric generator. The exhaust “gasses” from this process are carbon dioxide and steam.

Item 15, Heat Recovery Fluid ref FIG. 2 FIG. 3 and FIG. 4. Heated fluid item 15, is supplied by the Plasma Syngas Gasifier item 2, Catalyst item 11, and either Syngas Engine Electric Generator item 14, or Boiler Electric Generator item 13. It can be used for preheating the water supply to the Plasma Syngas Gasifier item 2, and/or the Boiler Electric Generator item 13. Other uses such as drying Feedstock items 7 and providing energy for a heat recovery electric generator are also possible.

Item 17, Flow Control Valve ref FIG. 1 through 4, regulates the carbon dioxide flow rate to the Algae Bioreactor item 2.

Item 18, Storage Tank And Water Separator, ref FIG. 1 through 4. Increased pressure and reduced temperature causes absorption of the carbon dioxide gas into the water. Inert and other accumulating gasses are then vented. Separation of the carbon dioxide is achieved once the water is returned to atmospheric pressure and temperature and agitated. Over filling the tank is avoided by controlling the current flow to the Plasma Torch, item 24.

Item 19, Outer Flow Loop, ref FIG. 1 through 4, is a closed recirculating loop where the carbon form is continually changing. i.e. from carbohydrate/hydrocarbon to carbon monoxide (syngas) to carbon dioxide back to carbohydrate/hydrocarbon.

Item 20, Inner Flow Loop ref FIG. 1 through 4, is a closed recirculating loop where undigested carbon dioxide and oxygen released during photosynthesis are fed from the Algae Bioreactor item 1, through the CO₂ Sensor item 21, to the Syngas engine item 14, or Boiler item 13. Here the flow rejoins the Outer Loop and returns back to the Algae Bioreactor.

Item 21, CO2 Sensor ref FIG. 1 through 3. The amount of carbon dioxide not being absorbed by the Algae Bioreactor is measured. This provides a feedback to Flow Control Valve item 17, where the carbon dioxide feed rate to the Bioreactor is adjusted to match the predetermined digestion capability of the Algae Bioreactor item 1.

Item 22, Oil Rich Carbohydrate Feedstock, ref FIG. 1 through 3, can either be fed back to the Plasma Syngas Gasifier item 2, and/or be used as a feedstock for syn-fuels or other products.

Item 23, Air Intake ref FIG. 2 FIG. 3 and FIG. 5. This is required if the oxygen from the Algae Bioreactor, item 1, is not available (i.e. during night time operation).

Item 24, Plasma Torch, ref. FIG. 1 and FIG. 2, is used to feed the electric arch inside the Plasma Syngas Gasifier chamber. By modulating the current flow to the torch the syngas output of the Plasma Syngas Gasifier is controlled.

### DESCRIPTION OF PREFERRED EMBODIMENT

As shown on FIG. 2, carbohydrate from the Algae Bioreactor (Item 1), and carbohydrate/hydrocarbon from landfills, sewage or other feedstock can be fed to the Plasma Syngas Gasifier (Item 2) to produce syn-gas. This is then fed to the Syn-gas Engine (Item 14), where during combustion the syn-gas (carbon monoxide and hydrogen) is converted into carbon dioxide and steam. To ensure that all carbon monoxide is essentially removed from the engine exhaust, the gas passes through Catalyst (Catalytic Converter Item 11) before being fed back to the Algae Bioreactor (Item 1) via the Water Separator/Storage Tank (Item 18) and Flow Control Valve (Item 17).

As shown on the embodiment in FIG. 3, the FIG. 2 system is modified to omit item 14, the Syn-gas Engine Electric Generator. This is replaced by item 13, the Boiler, This embodiment generates electricity from recovered waste.

As shown on FIG. 5, open loop nighttime running can be augmented by using stored hydrogen to generate electricity and/or by using the syn-gas output of the Plasma Syngas Gasifier as a syn-fuel feedstock.

It will be apparent to a person with ordinary skill in the art, that various modifications and variations can be made to the system for operating the generating system, without departing from the scope and spirit of this invention. It will also be apparent to a person of ordinary skill in the art, that various modifications and variations can be made to the size and capacity of the items in the range 1 through 24 shown on FIG. 2 through 5, without departing from the scope and spirit of this invention. Thus it is intended that the present invention cover the variations and modifications of the invention, providing they come within the scope of the appended claims and their equivalents.

1. A method and system to generate electrical power and/or hydrogen gas without releasing carbon dioxide greenhouse gasses into the atmosphere

2. A method and system providing inner and outer Carbon Flow Loops as a means of gathering, transporting and harvesting hydrogen.

3. A method and system to provide a self sustaining power generation from landfill sewage and other waste, while harvesting oil rich algae. This can be used to produce bio-fuels and solid biomass etc.
